(19) United States
(12) Patent Application Publication
(10) Pub. No.: US 2009/0303239 A1
(43) Pub. Date: Dec. 10, 2009

(54) METHODS AND SYSTEMS FOR CREATING AND EDITING A GRAPH DATA STRUCTURE

(76) Inventors: Darwin Ang, Gainesville, FL (US); Eric Poirier, Gainesville, FL (US); Ted Lavon Belser, II, Apalachin, NY (US); Marcin Karol Bardz, Rzeszow (PL)

Correspondence Address: STRATEGIC PATENTS P.C.., C/O PORTFOLIOIP, P.O. BOX 52050, MINNEAPOLIS, MN, 55402, US

(21) Appl. No.: 12/478,277

(22) Filed: Jun. 4, 2009

Related U.S. Application Data
(60) Provisional application No. 61/058,820, filed on Jun. 4, 2008.

(51) Int. Cl. G06T 11/20

(52) U.S. Cl. 345/440

(57) ABSTRACT

The present invention provides methods and systems to simultaneously create software applications and documents compatible to all electronic and print platforms from a single database source using graph database technology. The methods and systems may include a graph data structure having two or more points of data interconnected by a semantic relationship, and a transform for the conversion of the graph data structure into a platform data structure specific to a native platform application. The semantic relationship enables processing of the graph data structure into a plurality of distinct media. The platform data structure may include information to represent the data on the platform. Changes to the data may be made in the source graph data structure in order to update one or more platform data structures.

### CROSS-REFERENCE TO RELATED APPLICATIONS

This application claims the benefit of the following provisional application, which is hereby incorporated by reference in its entirety: U.S. Provisional Application No. 61/058,820, filed Jun. 4, 2008.

### BACKGROUND

1. Field

The invention generally relates to generating documents using graph database technology. More specifically, the invention relates to rendering documents compatible to all electronic and print platforms by using the graph database technology.

2. Description of the Related Art

With the burgeoning popularity of electronic content, different devices are used to read online. These devices may include iPhones, computer displays, PDAs, laptops, palm tops, handheld electronic devices, mobile devices, and the like. Since these devices work on diverse operating platforms, viewing content is not the same across the different platforms. A platform that may enable proper viewing of electronic content in different devices using a single source of data may be useful.

### SUMMARY

In an aspect of the invention, a system and machine readable medium, the machine readable medium having program instructions stored thereon, for ordering data stored in a data structure, executable by a processing unit, the program instructions comprising the steps of representing a graph data structure as a graph having vertices and edges, wherein each data point is defined as a vertex in the graph and each link between data points is defined as an edge between the vertices to form the graph, wherein each of the edges contains information about a semantic relationship between a pair of vertices connected by the edge, generating one or more platform data structures by using at least one rule to traverse the vertices and edges of the graph data structure to interpret the order of data presented in the graph data structure, wherein the platform data structure is specific to a native platform application, and rendering the platform data structure on the platform, wherein the platform data structure comprises information to represent the data on the platform, wherein changes to the semantic relationships among the data are made in the source graph data structure in order to update the one or more platform data structures. In an aspect of the invention, a graph data structure may include at least two points of data connected by a semantic relationship, the semantic relationship enabling processing of the graph data structure into a plurality of distinct types of media, and a transform that converts the graph data structure into a platform data structure specific to a native platform application, wherein the platform data structure comprises information to represent the data on the platform, wherein changes to the data are made in the graph data structure in order to update one or more platform data structures. In the system and medium, the semantic relationship may contain all of the information necessary for processing the graph data structure into the one or more platform data structures. The system and medium may further include a graph data structure interface for manipulating the semantic relationships among the data in the graph data structure. The graph data structure interface enables multiple users to edit a single graph data structure simultaneously. In the system and medium, the graph data structure may be a matrix structure. The matrix structure may be at least one of an incidence matrix, an adjacency matrix, a Laplacian matrix, a Kirchhoff matrix, an Admittance matrix, and a Distance matrix. The graph data structure may be a list structure. The list structure may be at least one of an incidence list and an adjacency list. The media may be at least one of an XML medium, a PDF medium, a Palm medium, a PocketPC medium, a Web medium, a Print medium, a personal computer medium, and a mobile device medium. In the system and medium, the data comprise at least one of numbers, symbols, characters, phrases, sentences, paragraphs, formulas, text, pictures, and videos. In the medium, the data structure may include metadata. In the system and medium, the data structure comprises digital rights management. In the system and medium, the platform may be at least one of SmartPhone, Web, mobile device, iPhone, Palm, PocketPC, computer, Apple computer, Print, Tablet PC, Symbian, and Android. In the medium, the platform data structure may include at least one of a PDF format, a Reader format, an XML format, and a native application format. In the system and medium, the graph data structure may be stored as a table of at least one of a vertex, an edge, and a parameter. The data in the vertex, edge or parameter is inherited from a different table. The table type may be one of a linked tight hierarchy, a configurable tight hierarchy, a loose hierarchy, a configurable loose hierarchy, an index table, a cross reference table, a grid table, a hints table, a figure table, a definitions table, a sounds table, an HTML table, an extended HTML table, a questionnaire table, and an extended calculator table. The calculator elements may include at lease one of an input field, formula text, a result, information, a report, and a report formula. The vertices of the questionnaire table may include at least one of a question vertex, a formula vertex, a score vertex, a hint vertex, a bookmark vertex, and a table type vertex. The vertex type may include a footnote, a popup, and a view mode. In the system and medium, the semantic relationship may be defined by linking at least two vertices to form at least one edge. The target and source of the link may be editable. In the system and medium, the graph data point is an image. The graph data structure may include platform-specific variants of the image. The correct platform-specific variant may be selected for display based on a tag associated with the image.

In an aspect of the invention, a method may include generating a graph data structure by defining data as vertices and defining the semantic relationship among the data as edges, exporting the graph data structure to a platform data structure, and rendering the platform data structure with a platform executable code. In the method, the semantic relationship may contain all information necessary for processing the graph data structure into a plurality of distinct media.

In an aspect of the invention, a machine readable medium, the machine readable medium having program instructions stored thereon, for processing data stored in a data structure, executable by a processing unit, the program instructions may include the steps of representing a data structure as a graph having vertices and edges, wherein each input field of the data structure is defined as a vertex in the graph and each link between input fields is defined as an edge between the vertices to form the graph, wherein each of the edges contains information about a formulaic relationship between a pair of vertices connected by the edge, and generating a results report by using at least one rule to traverse the vertices and edges of the graph to interpret the formulaic relationship of the data presented in the graph data structure. In the medium, the formulaic relationship may contain all formulas necessary for processing the graph data structure into a plurality of distinct platform data structures. The program instructions may enable multiple users to edit a single graph data structure simultaneously. In the medium, the input fields may include at least one of a formula text, a result, a symbol, a number, a character, a checkbox, a radio button, a drop-down menu item, a report, and a report formula.

In an aspect of the invention, a machine readable medium, the machine readable medium having program instructions stored thereon, for processing data stored in a data structure, executable by a processing unit, the program instructions may include the steps of representing a data structure as a graph having vertices and edges, wherein each input field, question, formula, and score of the data structure is defined as a vertex in the graph and each link between input fields is defined as an edge between the vertices to form the graph, wherein each of the edges contains information about a semantic relationship between a pair of vertices connected by the edge, and a results report generated by using at least one rule to traverse the vertices and edges of the graph to interpret the semantic relationships of the data presented in the graph data structure, wherein a user's answer to at least one question is stored in connection with at least one vertex or at least one edge in the graph data structure and wherein the user's answer is used in connection with the rule. In the medium, the semantic relationship may contain all information necessary for processing the graph data structure into a plurality of platform data structures. The program instructions may enable multiple users to edit a single graph data structure simultaneously.

These and other systems, methods, objects, features, and advantages of the present invention will be apparent to those skilled in the art from the following detailed description of the preferred embodiment and the drawings. All documents mentioned herein are hereby incorporated in their entirety by reference.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

FIG. 1 depicts a system having hardware and an operating environment with which various embodiments of the present invention may be practiced.

FIG. 2 depicts various hardware components associated with the computing device on which various embodiments of the present invention may be practiced.

FIG. 3 depicts various program modules associated with application programs which may interact with a project in accordance with various embodiments of the present invention.

FIG. 4 depicts various hardware components of a graph database interface to edit structural elements.

FIGS. 5 and 6 depict a flowchart to view the platform database in accordance with various embodiments of the present invention.

FIG. 7 depicts an exemplary calculator table for processing the data in the computing device.

FIG. 8 depicts an exemplary questionnaire table for processing the data in the computing device.

FIG. 9 depicts an exemplary table being edited by the hierarchy editor.

FIG. 10 depicts an exemplary table being edited by the hierarchy editor.

FIG. 11 depicts an exemplary index being edited by an index editor.

FIG. 12 depicts a flowchart representing a method of a graph database.

FIG. 13 depicts a flowchart representing a method of a calculator table.

FIG. 14 depicts a flowchart representing a method of a questionnaire table.

### DETAILED DESCRIPTION

While the specification concludes with the claims defining the features of the invention that are regarded as novel, it is believed that the invention will be better understood from a consideration of the following descriptions in conjunction with the drawings/figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defied as one or more than one. The term “another,” as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

In an embodiment, through the graph database manipulation system 104, a user 312 may describe the relationships between structural elements in electronic content. In an exemplary scenario, the chapter, section, and subsection organization of an e-book may be defined by the order and visual presentation of headings in a print document. The heading for a chapter may be styled in a way to indicate to the reader that it is the chapter heading. The section heading and other subheadings for nested sections may be formatted to set them apart. The visual formatting may not provide a strict relationship between the chapter and sections (or subsections) that it may contain.

If the e-book is in an XML format, the chapter may contain tags at the beginning and end of the content. All tags inside the content, such as section or subsection tags may be nested in the chapter tag. An exemplary structure for the XML format may be:

<chapter>

<section>

<subsection>
</subsection>

</section>

</chapter>

This structure may create a strict definition between the chapter, section and subsections. However, this format may still be incomplete. A subsection may not contain any inherent data that may indicate what its parents are (i.e., the section or chapter it belongs to). It may also be missing information about siblings (i.e., subsections that are children of the same section). Furthermore, XML may not strictly enforce this nesting behavior.

The graph data structure of the relationship between sections and sub-sections may be defined in the graph database 302. Each chapter (defined as a vertex) may have a relationship with all sections and subsections. Furthermore, when the data may be exported to a different platform, the structural relationships may be maintained in graph data structure thereby providing easy conversion into other formats.

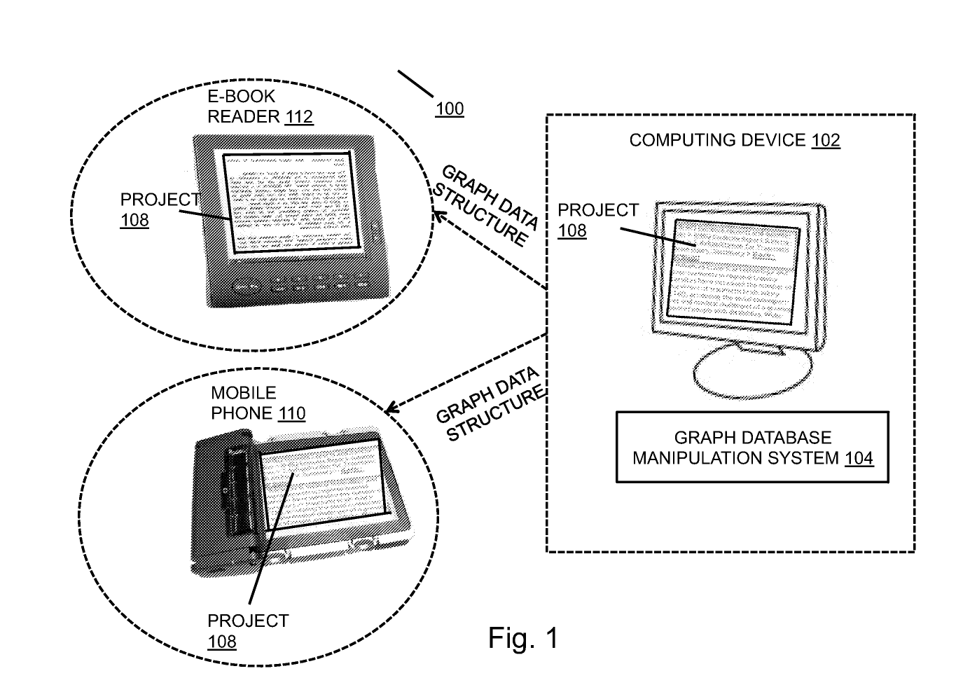

FIG. 1 describes a system 100 having hardware and an operating environment with which various embodiments of the present invention may be practiced. The system 100 may include a computing device 102. The computing device 102 may include a graph database manipulation system 104 and a project 108. The project 108 may be an e-book, a research paper, a tutorial, an electronic write-up, an essay, a website, a patient record, a database, or some other kind of electronic document or content. The project 108 may include files, software objects, libraries and the like. It may be noted that the present invention may be explained by using the example of an e-book as the project 108, but it should be understood that the project 108 may be any electronic content. However, those skilled in the art may appreciate that project 108 may be an electronic document that may be displayed on an electronic device.

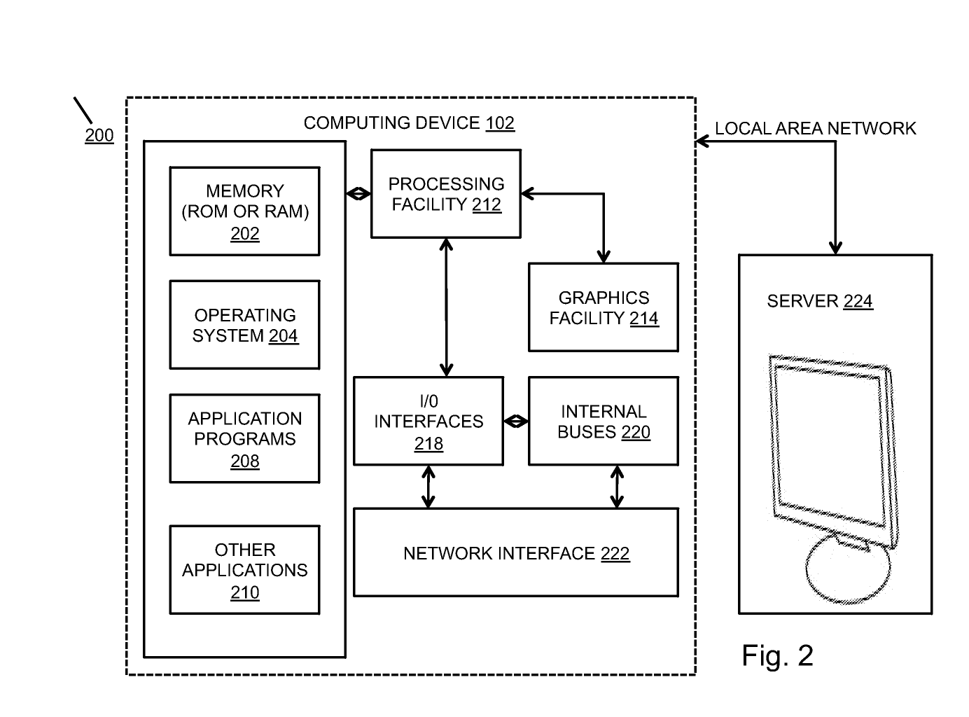

In embodiments, the source of the project 108 may be in different formats. Examples of the different types of formats may include, but may not be limited to PDF, TIFF, XML, XPS, PS, JPEG, DOC, or some other type of format. In an exemplary scenario, a medical publishing company may have an e-book with a section on smoking cessation. In this scenario, the medical publishing company may want to adapt this e-book for users using different portable devices. For example, the users may use an IPHONE, BLACKBERRY, a desktop computer, a PALM PILOT, PDA, or some other type of device. In this scenario, the e-book may be referred to as a project 108. The e-book may be adapted to different formats viewable by the devices by using the graph database manipulation system 104. For example, the e-book may initially be in PDF, but PDF may not be a format amenable to navigation on a mobile phone 110, an e-book reader 112, and the like. The graph database manipulation system 104 may take the data from the e-book in its PDF form and may organize it according to a graph data structure using a graph data structure editorial interface (explained in conjunction with FIG. 2 onwards). Accordingly, the portable devices (a mobile phone 110 and an e-book reader 112 as shown in FIG. 1, as well as any others) may now be able to view and navigate the e-book by virtue of its transformation to a graph data structure.

It may be noted that FIG. 1 may be shown to have the mobile phone 110 and the e-book reader 112. However, those skilled in the art would appreciate that the e-book may be viewed in any computing device enumerated herein, as well as those not enumerated herein.

FIG. 2 depicts various hardware components associated with the computing device 102 on which various embodiments of the present invention may be practiced. Those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that may be linked through a communications network.

In a distributed computing environment, program modules may be located in both local and remote memory storage devices. The exemplary hardware components of the computing device 102 for implementing the invention may include a memory 202, operating system 204, application programs 208, other applications 210, processing facility 212, graphics facility 214, I/O interfaces 218, internal buses 220, a network interface 222, and the like. There may be one or more than one processing facility 212, such that the processor of the computing device 102 comprises a single central-processing unit (CPU), or a plurality of processing units, commonly referred to as a parallel processing environment. The computing device 102 may be a conventional computer, a distributed computer, or any other type of computer. The memory 202 may also be referred to as simply the memory, and may include read-only memory (ROM) and random access memory (RAM). It should be appreciated by those skilled in the art that any type of computer-readable media which can store data accessible by a computer, such as magnetic cassettes, flash memory cards, digital video disks, Bernoulli cartridges, random access memories (RAMs), read only memories (ROMs), and the like, may be used in the exemplary operating environment.

In embodiments, a number of application programs 208 may be stored in a hard disk, magnetic disk, optical disk, ROM, or RAM, and the like. In embodiments, the computing device 102 may interact with the server 224 in a local area network through the network interface 222. The hardware and operating environment in conjunction with which embodiments of the invention may be practiced has been described. The computing device 102 may also include a communications device such as a network adapter or a modem, so that it may be able to interact with other computers.

In embodiments, the computing device 102 may execute different application programs 208. An example of an application program 208 may be a program developed for converting e-books into a format amenable to multiple device deployment.

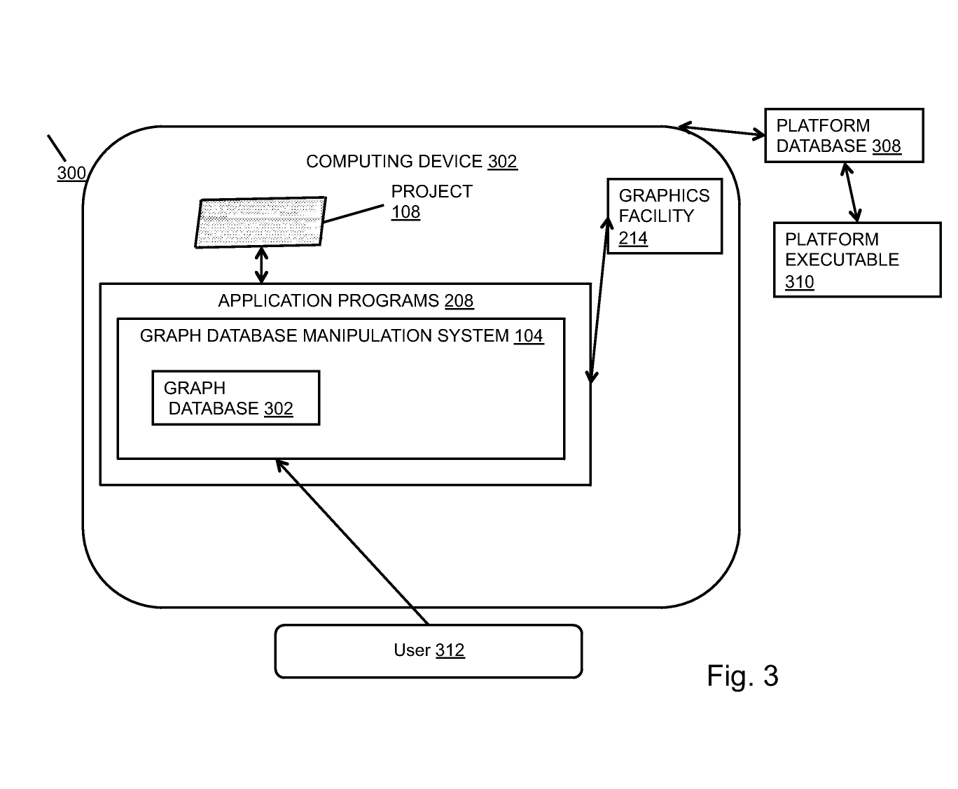

FIG. 3 depicts the various program modules associated with the application program 208 which may interact with the project 108 in accordance with various embodiments of the present invention. The application program 208 may include desktop processing applications (not shown in FIG. 3), spread sheets applications (not shown in FIG. 3), antivirus applications (not shown in FIG. 3), presentation applications (not shown in FIG. 3), animation applications (not shown in FIG. 3), database applications (not shown in FIG. 3), image processing applications (not shown in FIG. 3), and the like. In addition, the application program 208 may include the graph database manipulation system 104. The graph database manipulation system 104 may convert an input file format into a graph structure which may be processed for execution on different kinds of operating platforms. As described in FIG. 1, the graph database manipulation system 104 may take the input format of the project 108 and convert it into a graph data structure. Referring to the above stated example, the project 108 may initially be in a format, such as a PDF format. The graph database manipulation system 104 may convert the PDF format into a graph data structure. The project 108 may initially be in any format, such as word processing format, spreadsheet format, presentation format, XML format, PDF format, reader format, XPS format, postscript format or in some other type of format.

The graph database manipulation system 104 may include a graph database 302. The graph database manipulation system 104 may export the graph database 302 as a platform database 308, which may be viewed or rendered by a platform executable 310.

The graph database 302 may be a collection of vertices and edges that may represent data in a semantically correct way. All of the intended semantic relationships between data subsets may be represented in the graph file. Continuing the above stated e-book example, the PDF file may be parsed to form a graph data structure of vertices and edges. This graph data structure may be stored in the graph database 302. The relationships may be defined in the file (such as a txt file or an xml file) and the file may be parsed automatically by a software program to construct the graph relationships. Alternatively, the file may be parsed via a manual indexing feature, or in some combination of automatic and manual parsing. In another example, the txt file may be accessed in real time, and the structural relationship may be constructed in parts in the memory 202 associated with the platform, when required, thus saving memory 202 space. Continuing with the e-book example, the various chapters and sub-sections of the e-book may be parsed such that each chapter becomes a vertex, each chapter sub-section becomes a vertex, each image in the chapter becomes a vertex, each table in the e-book becomes a vertex, each footnote becomes a vertex and so on. Every content element of the e-book may become a vertex. In this example, the graph data structure, which may be constructed as a table using the graph database manipulation system 104, may relate the various content elements by using a hierarchy or using the order in which the content was presented. For example, in an e-book with chapter subsections, an order may be defined in which the subsections should be presented. Because the data are in a graph data structure, it is easy to manipulate the order and relationship of the data. For example, data from different Chapters, such as Chapters 2 and 3 in this example, can be included in or inherited into Chapter 1 if they are related without altering the original relationship of the data within the source Chapters.

In embodiments, the graph database manipulation system 304, also known as a graph database interface, may display the relationships among different structural elements in the graph database 302. The graph database 302 may be exported to generate a platform database 308. In embodiments, a plurality of platform databases 308 may be stored in the graph database manipulation system 104, which may contain all the information necessary to represent the data on a specific platform. For example, the platform database 308 may store a PDA format, which may be made available to the PDA requesting the e-book. The data may be rendered as an application to navigate the content.

The platform executable 310 may be a software program specifically compiled for the different platforms. The platform executable 310 may be used to view or render the platform database 308. In embodiments, the platform executable 310 may provide an environment for viewing the project 108 on a particular device. In addition, the platform executable may allow the user 312 to view the project 108 in different modes, but may not be limited to lists, searchable index, html, searchable html, and the like.

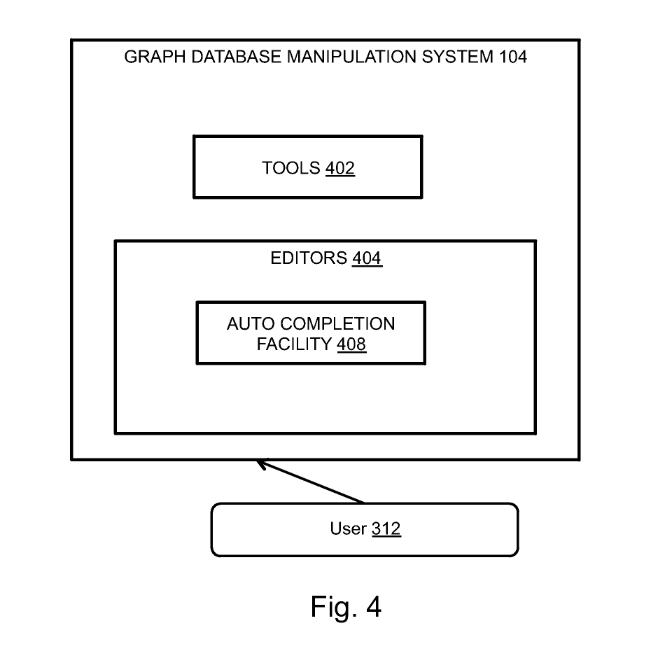

In embodiments, referring to FIG. 4, the graph database manipulation system 104 may display, manipulate and edit the relationships among different elements in the graph database 302. The graph database manipulation system 104 may include editors 404 and tools 402. An editor 404 may be an interface used to manipulate and represent data. A tool 402 may be an interface that aids an editor 404 in its purpose of manipulating the data. For example, an editor 404 may be used to manipulate text, create fields, add in line breaks, and the like. If a link is needed between part of the text and another part of the graph, then a link tool 402 may be used to create the link. It may be noted that FIG. 4 shows some of the features available in the editor 404 and/or tools 402. However, those skilled in the art would appreciate that editor 404 may include other features as known in the art without deviating from the scope and spirit of the invention.

Each project 108 may comprise multiple tables representing content. Each table may be of a particular type. Each table may represent a hierarchy item, a link, content, a figure, a calculator, a questionnaire, a flowchart, an index, and the like. Hierarchy items may be organizational elements that do not have directly associated content. For example, when a list tables tool is used to access all of the tables associated with a project, the table type and the table title may be listed. Clicking on the table may launch an editor associated with that table capable of manipulating the data in that table. As the hierarchy is navigated to lower levels, additional hierarchy items, links, and content may be reached. The content may be parsed into fields of the table.

In embodiments, the table may be of multiple types. The two major table types are “Linked Tight” and “Loose”. These classifications have to do with how the table treats fields. In a Linked Tight Hierarchy, the field order that is displayed is linked to the field order in the list of fields. It is “tight” because it can't duplicate fields, hide fields, or display them in a different order from the field list. A loose hierarchy may display a subset of fields from the field list, in any order, and duplicate fields. Other table types include ‘inherited,’ configurable tight hierarchy, configurable loose hierarchy, index table to represent an index section in a book, cross reference table to represent data that falls under more than one category, grid table to represent tabular table, hints table, figure table, definitions table to describe abbreviations, sounds table, HTML table for text with html tags, extended HTML table for text with html tags and jump features, extended calculator table, questionnaire table and the like. Tables may form hierarchy and may contain some of the fields referred to as ‘loose’ hierarchy. In ‘loose’ hierarchies, the editor 404 may pick and choose which fields to present for each table and the order in which to present them. Indeed, the editor 404 may choose to present more than one entry of the same field. In embodiments, the fields may be associated with the headings of the eBook. For example, the medical practicing may have chapter; each chapter may be associated with different heading. The heading may be exported into corresponding field by the graph database manipulation system 104. In embodiments, the fields may allow collating the data under heading. This enables the data to be identified under one heading and/or field. For example, the heading may describe a process of preparing a drug for treatment of cancer. The graph manipulation system 104 may export the heading into the corresponding field during conversion. In this scenario all the data under field will be collated under the heading ‘treatment of cancer’.

In embodiments, the field corresponding to a particular heading may be identified with the heading. For example, the heading ‘treatment of cancer’ may be exported into corresponding field named ‘treatment of cancer’. Alternatively, the heading associated with a particular field may be identified by a different name. This relation may be termed as loose hierarchy.

In embodiments, the table hierarchy may be a ‘tight’ hierarchy. In ‘tight’ hierarchies, all the fields defined may be used for the table with one instance only and may be presented in a particular order.

In embodiments, each ‘tight’ and ‘loose’ may be categorized as configurable or index. This sub-categorization may relate to the data that may be viewed when the graph file may be exported to create the graph database 302. In embodiments, the relationship between the field and the heading may be configurable. The term configurable refers to presentation of data in different views. The presentation of the data on the device may depend upon the view mode set in the computing device 102. For example, the configurable data may be presented in the normal view. In another example, the configurable data may be presented to the user 312 in searchable index, index, list, html, html list, and the like.

In embodiments, the table hierarchy may be of an ‘inherited’ type. Continuing with the example from above, while one chapter of this e-book may be devoted to the antifungal, terbinafine tablets, there may be other chapters for terbinafine oral granules and terbinafine cream. Since these three are all related, they may share data. The tables for each entry may be set up as ‘loose’ and within each table, specific fields may be set to ‘inherit’ the data from another entry. Further, the inherited type may only be associated with the ‘loose’ type hierarchy since the ‘loose’ type only allows sharing of some fields. In embodiments, the table may be a calculator table 702, a questionnaire table, and the like. These tables may interact with the user 312 to provide desired reports.

In embodiments, the graph data structure may be stored in a table form. The table may include a list of vertices, a list of edges, a list of parameters and the like. Further, the vertexes may include a footnote, a popup, a view mode, and the like.

In embodiments, the editor 404 may be a hierarchy editor, an index editor, a figure editor, a calculator editor, an extended calculator editor, a questionnaire editor, a flowchart editor, a text editor, an html editor, an XML editor or some other type of editor. The editor 404 may have properties for changing the color, font of the data, and the like. For example, the editor may use a ‘bold’ property to make first few words of the text bold.

In embodiments, the editor 404 may facilitate navigation and analysis of the content. For example, if the content is very large, the editor 404 may divide the content into multiple screens for ease of navigation. Further, the user 312 may be interested in analyzing the content in a particular tag. The user 312 may enable the highlighter in the editor 404 for highlighting the occurrences of the tag for analysis purposes. For example, the user 312 may highlight all the hyperlinks present in an e-book for reconfiguration.

The editor 404 may include an auto-completion facility 408. The editor 404 may be coupled to a dictionary maintaining the list of auto-completion words. For example, the user 312 may input only the first alphabet and the intuitive auto-completion facility 408 may suggest the list of words. In another embodiment, the auto-completion facility 408 may facilitate the auto-completion of software codes with proper syntax and tags.

The editor 404 may facilitate the navigation of different files, tables, and content elements within the project 108. The editor 404 may allow rearrangement of files through a drag and drop facility. For example, the user 312 may be interested in rearranging the content files; the editor's navigation facility may allow the user to reorganize the content files using a drag and drop facility.

In embodiments, an index editor 1100 may facilitate the creation of ignore lists 1102, sorting of fields and content, adding or removing index items, rapid indexing of content, moving index items up or down, and the like. In an embodiment, a user may be able to set how an index is sorted and what priorities are given to particular elements. For example, a user may indicate that bold headings are to be sorted to the top of the list, such as by selecting a variant in a list of sorting preferences. When the user indicates that they want to sort the index, the preferences will be accessed by the index editor in order to facilitate the sort. In another embodiment, an ignore list may be generated. For example, a title such as ‘For Smoking Cessation’ might preferentially be sorted by the terms pertaining to the content, that is, ‘Smoking Cessation’. In order to accomplish that, the term ‘for’ would have to be ignored. Placing the term ‘for’ on an ignore list enables the sort to occur on the only the non-ignored terms. In embodiments, each project 108 may have multiple indices. The index editor may also be used to create links to index items. For example, the index tree 1104 depicts a number of index items. One of the items 1108, labeled ‘Abdominal Aortic Aneurysm (AAA)’, has a warning sign near it indicating that the index item does not link to any content. Indeed, the link field 1110 is empty. A link to content may be generated by opening up the table where the content to be linked resides and dragging and dropping the index item onto the content. The link will automatically appear in the link field 1110 and the warning sign will disappear. In an embodiment, the index editor may also be able to generate a dual list table to depict a one-to-one or one-to-many relationship between two lists of terms. For example, a list of generic pharmaceutical names may be related to a list of brand name pharmaceuticals by linking the generic pharmaceutical name on one list with one or more branded pharmaceutical names on the second list.

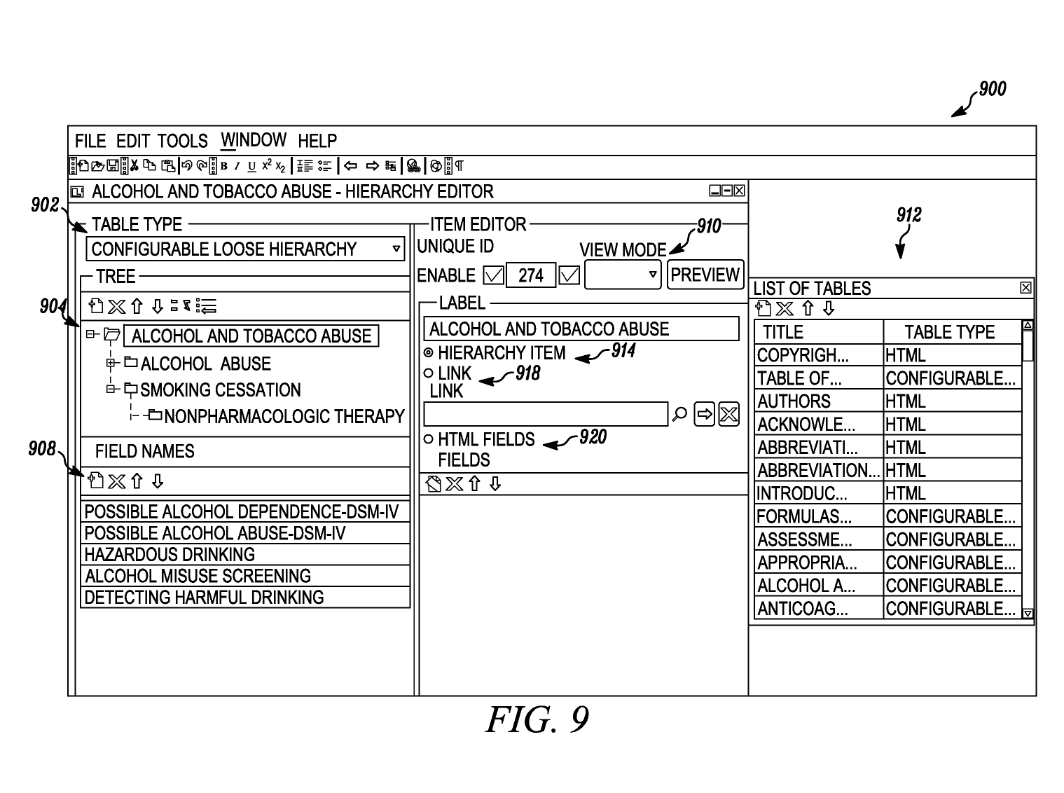

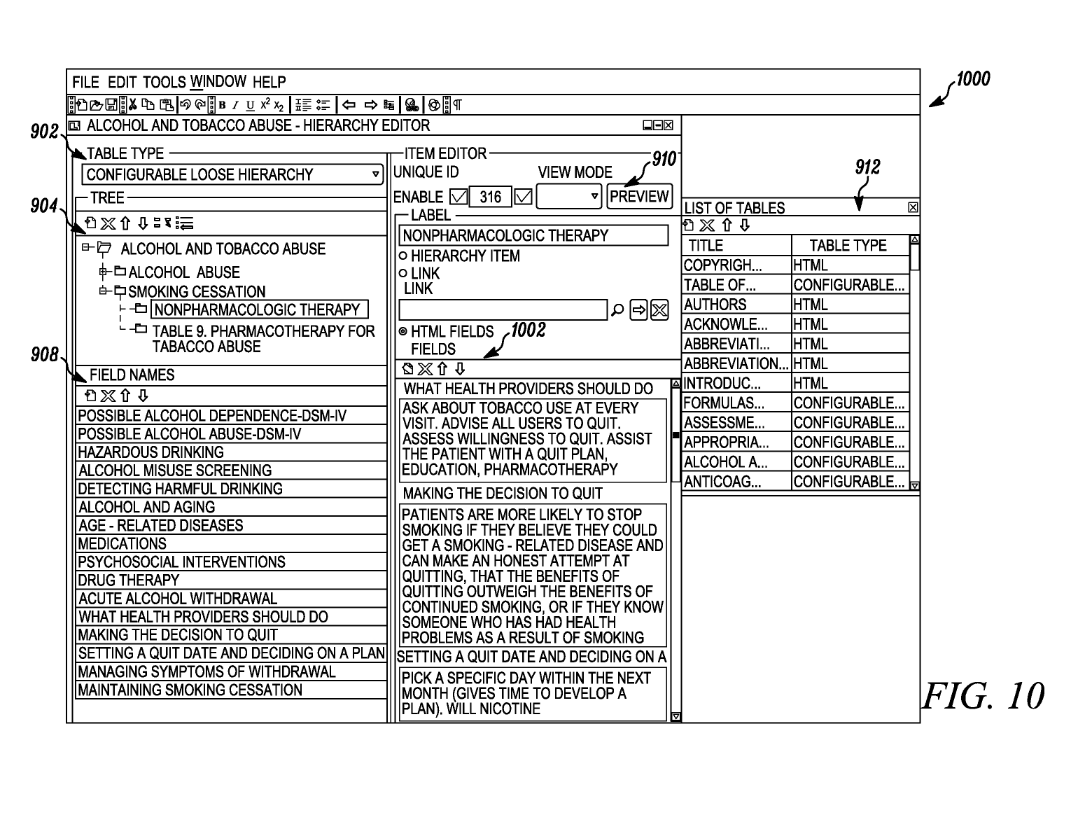

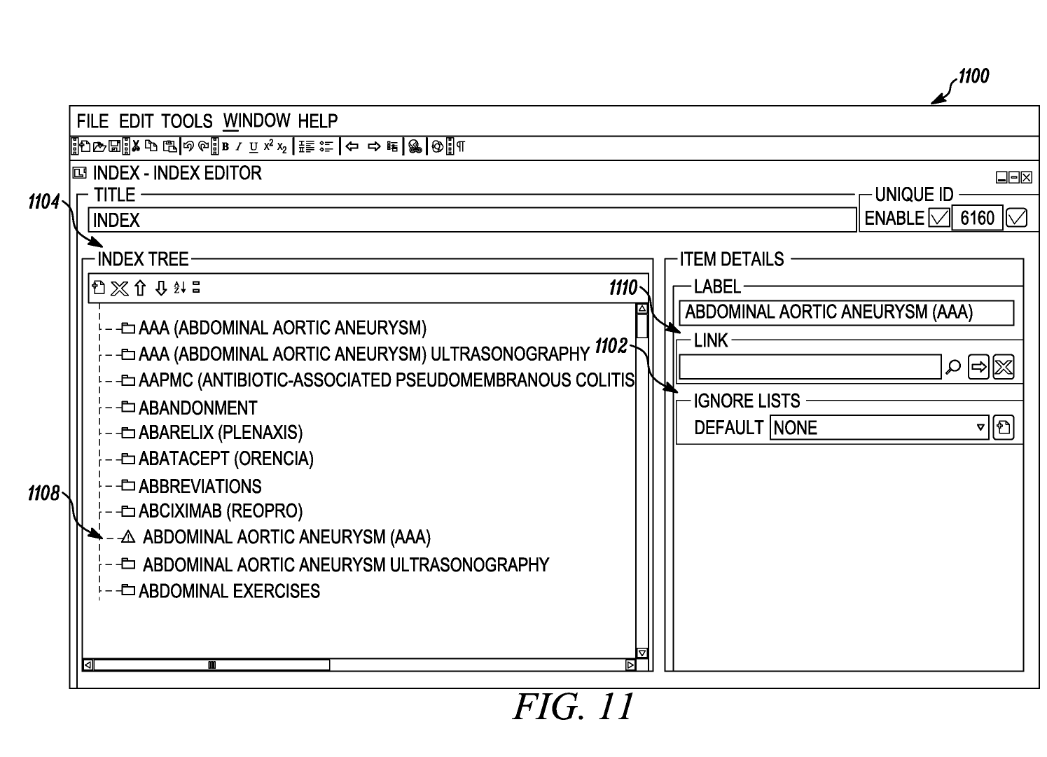

In an embodiment, a hierarchy editor may facilitate creating hierarchy connections, which may be handled as vertices. In some embodiments, the hierarchy editor may be enabled by a rapid import tool. For example, continuing with the example of the project 108 being an e-book in an original PDF format, in order to rapidly import the hierarchical structure, the Table of Contents may be copied and pasted into a hierarchy table. Then, the pasted Table of Contents may be manipulated, such as to remove page numbers, leading symbols, turn the Table of Contents into a list, and the like. Generating the hierarchical structure from the list of headings may involve indenting elements of the Table of Contents to indicate a hierarchical relationship of the content. In order to continue with rapidly importing content, field names may be added to the project 108. For example, a prescribing reference e-book may comprise entries for prescribed drugs where each entry has various possible fields of data, such as Legal Class, Manufacturer, Pharmacological Class, Generic Description, Indication, Contraindications, Prescribing Information, Precautions, Interactions, Adverse Reactions, Dosage Form, Synergistic Combinations, and Generic Version Availability. Each field name may be added to the project 108. Then, each entry may be imported by copying the entry to a hierarchy table. The system 104 then automatically parses the data by searching for the field names. When the system locates a field name, it grabs the text immediately below the field name as the content pertaining to that field. The content continues to be associated with that field name until the system 104 identifies the subsequent field name. Then, content is imported as associated with the next identified field name. Once imported, the content may be manipulated such as to remove or add line breaks, create links, and the like. It should be understood that the hierarchy may also be generated manually. Referring to FIG. 9, in another example, a table of a medical prescribing project 108 dedicated to ‘Alcohol and Tobacco Abuse’ 900 may be selected from a list of tables 912. This table type is configurable loose hierarchy, but can be modified by selecting another table type from the drop down menu 902 to any one of linked tight hierarchy, loose hierarchy, configurable tight hierarchy, inherited hierarchy, and the like. The hierarchy tree depicts the organization of content within the table, as each next level of hierarchy is selected, the portion of the table for that level of hierarchy is accessed. In some embodiments, a new table may be accessed. In this case, the top level hierarchy item is ‘Alcohol and Tobacco Abuse’, and there are two hierarchy items below that: ‘Alcohol Abuse’ and ‘Smoking Cessation’. Below ‘Smoking Cessation’ are two items, ‘Nonpharmacologic Therapy’ and ‘Table 9. Pharmacotherapy for Tobacco Abuse’. In the tree view 904, new items may be added to or deleted from the hierarchy, items may be moved up or down in the hierarchy, items may be inserted, fields may be imported from the clipboard to populate the hierarchy, a hierarchy may be imported from a clipboard or some other source, and the like. All of the field names 908 associated with the table may be shown. Field names 908 may be added, deleted, moved up or down in order, and the like. Because the table type in this example is configurable, a view mode 910 may be selected from a drop down menu. The view modes 910 impact how the table is rendered on an end user device. View modes 910 may be index, list, html list, searchable index, and the like. Because this table represents a top level hierarchy item, the radio button for ‘Hierarchy Item’ 914 is selected and the Link 918 and HTML Fields 920 for content are not accessible. In FIG. 10, the hierarchy has been navigated to an item for which there is content. The Label for the content is ‘Nonpharmacologic Therapy’ and certain fields have been selected from the available fields for this table to be populated with content. In the HTML fields 1002, content is shown parsed under particular Field Names 908. Fields can be reorganized by clicking on the field name and selecting a different field, moving fields up and down, adding and deleting fields, and the like. Because this is a loose hierarchy, fields are selected (even duplicate fields) and not every field is automatically shown in the table. In a tight hierarchy, every field would be shown in the table whether or not there is available content under that field name, and the order in which the fields appear would be fixed.

In an embodiment, a figure editor may enable setting image variants. In the graph database manipulation system 104, in order to render an image on a platform properly, the image may need to have a specific resolution or color. Thus, the graph data structure may need to have an image variant for each supported platform on which the graph data structure will be rendered as an exported platform data structure. The image tool may manage the variants needed for each platform, such as high resolution, mid-resolution and low resolution variant for each supported platform. The figure editor may enable uploading individual variants for the same figure. A video tool and an audio tool may work similarly to the image tool.

In embodiments, the editor 404 may include a grid editor. The grid editor may allow the user 312 to add, delete, or re-order rows and columns of a data table, format the data as a table of vertices and edges, and the like. Content may be added or inherited for each entry of the data table. In some embodiments, the data table may be a cross-reference table. The cross-reference table may be presented as a hierarchy, such that there may be a hierarchy of column and row headings. Once the cross-reference table is rendered, users may drill down in the table by highlighting rows and columns in order to isolate a cross-section of data from the cross-reference table.

In an embodiment, a calculator editor may be used to edit a calculator table. The calculator table may be used for processing the data in the computing device 102 in accordance with various embodiments of the present invention. Continuing with the above example, the e-book may contain formulas for calculating the dosage to be provided to a cancer patient. The user 312 may be interested in calculating a dosage to be provided to the cancer patient using a particular formula. The formula may be provided in the e-book. The graph database manipulation system 104 may be adapted to convert the stated formula into a calculator table. The user 312 may interact with the calculator table for calculating the amount of medicine to be provided to the cancer patient. In this example, the calculator table may have the following available fields for data input: body weight, age, concentration of the stock drug, dosage form, required dose, desired peak, desired trough, gender, units, multipliers, and some others type of parameters. In addition, the calculator table may have input fields that may include the patient's body weight, desired peak, desired trough, concentration of stock drug, and the like. The calculator table may be represented in the form of a data structure in the memory 202 of the computing device 102. It may be noted that the data structure explained in this embodiment may be in the form of a graph. However, those skilled in the art would appreciate that the data structure may also be represented in the form of a tree, forest, and the like. In embodiments, each of the input fields may be represented as the vertex of the graph. In addition, the relationships between each of the input fields may be taken as the edges of the graph. In the calculator table, certain fields and inputs may be inherited.

In embodiments, the calculator table may have an option for inputting a maximum value for a particular variable, minimum value for a particular variable, range of a particular variable, and the like. For example, a patient's age may be entered as between 0-18 years. In embodiments, there may be a different calculator table for calculating formulas for different age groups. For example, the calculator table may have a formula that may calculate the required dose using the above stated variables. The calculator table may calculate the dosage of drug to be provided to the cancer patient based on the formula given in an e-book. In another example, the calculator table may be used to determine an APGAR score. The calculator table may have fields for heart rate, respiratory effort, muscle tone, reflex irritability, color, and the like. For each field, the user may input a score of 0, 1, or 2. The calculator table may calculate a final APGAR score based on the input provided by the user 312. The calculator table may be set to provide a report. For example, if the APGAR score is greater than 8, a first report may be produced. If the APGAR score is 5 to 8, a second report may be produced. And if the score is below 5, a third report may be produced. An exemplary first report, second report and the third report may be “APGAR score is % total APGAR %. Contact pediatric specialist immediately.” In embodiments, the result report may be generated by traversing the vertices and the edges of the graph to interpret the formulaic relationships of the input fields.

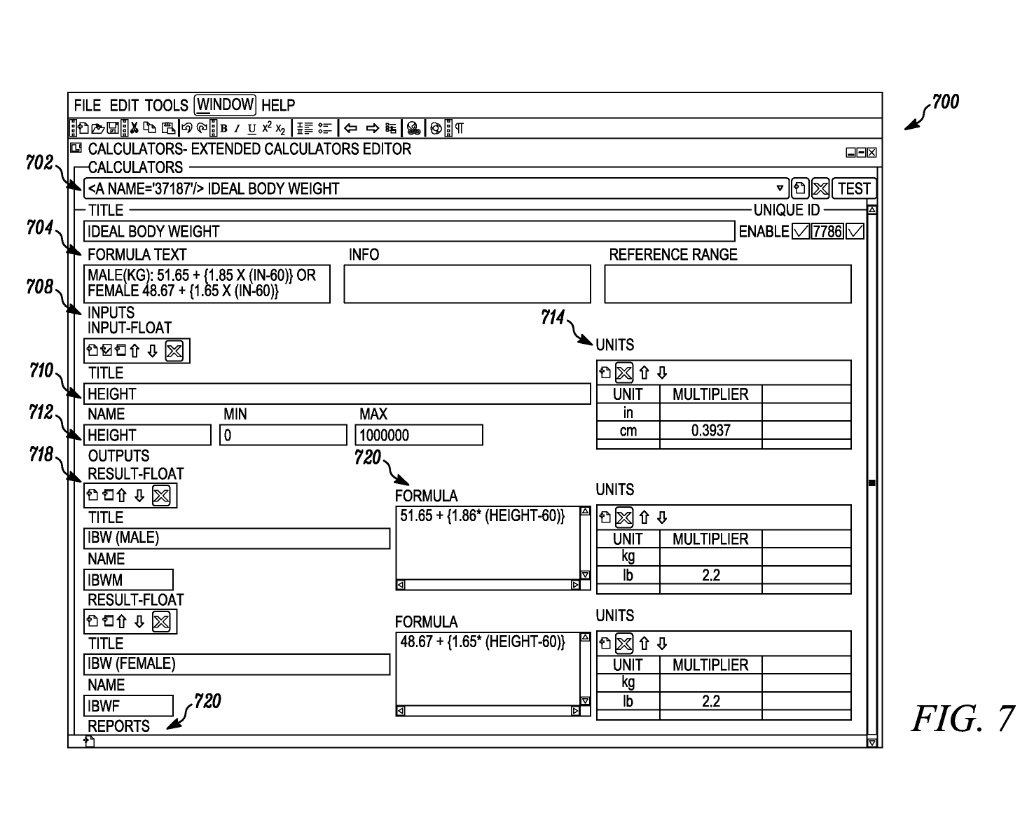

Referring to FIG. 7, an exemplary calculator table is edited by a calculator editor. All of the calculators for a particular project 108 may be accessed using a drop down menu 702. For each calculator, formula text 704, information, reference range, and the like may be indicated. Inputs 708 to the calculator may be defined. Inputs 708 may be numeric, a radio button selection, a drop down menu selection, a variant selection, a text entry, a checkbox, and the like. For example, a new input field may be added, an input variant field may be added, a new date field may be added, inputs may be deleted, moved up or down and the like. For each input, a title 710 may be given and an input range 712 may be set. In this example, the formula 704 relates to calculating an ideal body weight and the input 708 is height. The input range 712 is set from a minimum to maximum. For each input, units 714 are given for the input 708. Multiple units may be possible for input as a multiplier may be provided to enable the input to be transformed into a variable usable by the formula. The output 718 may be result of plugging the input 708 into the formula 720. Units may also be provided for the output, and multiple units may be possible for output as a multiplier may be provided to enable the output to be converted from one form to another. In some embodiments, a report 720 may be generated based on the output 718.

In an embodiment, a questionnaire editor may be used to edit a questionnaire table. For example, a project 108 may have a questionnaire. The graph database manipulation system 104 may generate a questionnaire table. The questionnaire table may have different input fields which may include but may not be limited to question, formula, score of the questionnaire, and the like. These input fields may be defined as the vertices of the graph. In addition, the link between each of the input fields may be taken as the edges to form the graph. The edges may contain the semantic relationship between the pair of vertices. In embodiments, the questionnaire table may be in the form of a graph data structure, and the vertexes of the graph data structure may represent a question, a formula, a score, a hint, a bookmark, a table and the like. In the questionnaire table, certain fields and inputs may be inherited.

In the questionnaire table, the questionnaire may have a set of answers associated with the question or request for information in each field. For example, the questionnaire may be a heart disease risk questionnaire. One question of this questionnaire may be: Are you a smoker? The field may have various ways to enter the answer, such as a radio button, a check box, a drop down menu, text entry, and so on. In this example, the user may input a radio button entry to answer ‘Yes, I am a smoker.’ The questionnaire table may associate a score with this answer for use in an embedded calculator. Other questions may be age, blood pressure, weight, gender, cholesterol levels, diabetes status, and the like. Each answer may generate additional data that may be associated via a formula which may be used by an embedded calculator to calculate the final heart disease risk and may also point the user to subsequent questions or terminate the questioning and generate a report. In embodiments, the formulas may be input using any mathematical notation system, such as direct algebraic logic, Reverse Polish Notation (postfix notation), prefix notation, infix notation, and the like.

In embodiments, the user's answers to the questions may be stored as vertices or edges in the graph data structure. A report may be generated as described above similar to the report of the calculation table. In embodiments, the report may be generated by traversing the edges and vertices of the graph to interpret the semantic relationships of the data presented in the graph data structure. In embodiments, the questionnaire table may be accessed simultaneously by multiple users. Each user may provide different inputs to the questions, and different reports may be simultaneously provided to different users. In the questionnaire table, the question may be defined, inputs may be assigned such as numeric input, a radio button, a check box, a menu item, a text field, and the like. For each option, a label, a variable name, and/or a formula may be provided. After answering one question, the table may lead the user to a next question or to a report, similar to the flow of a flow chart. At the end of the questioning, the questionnaire table may generate a report.

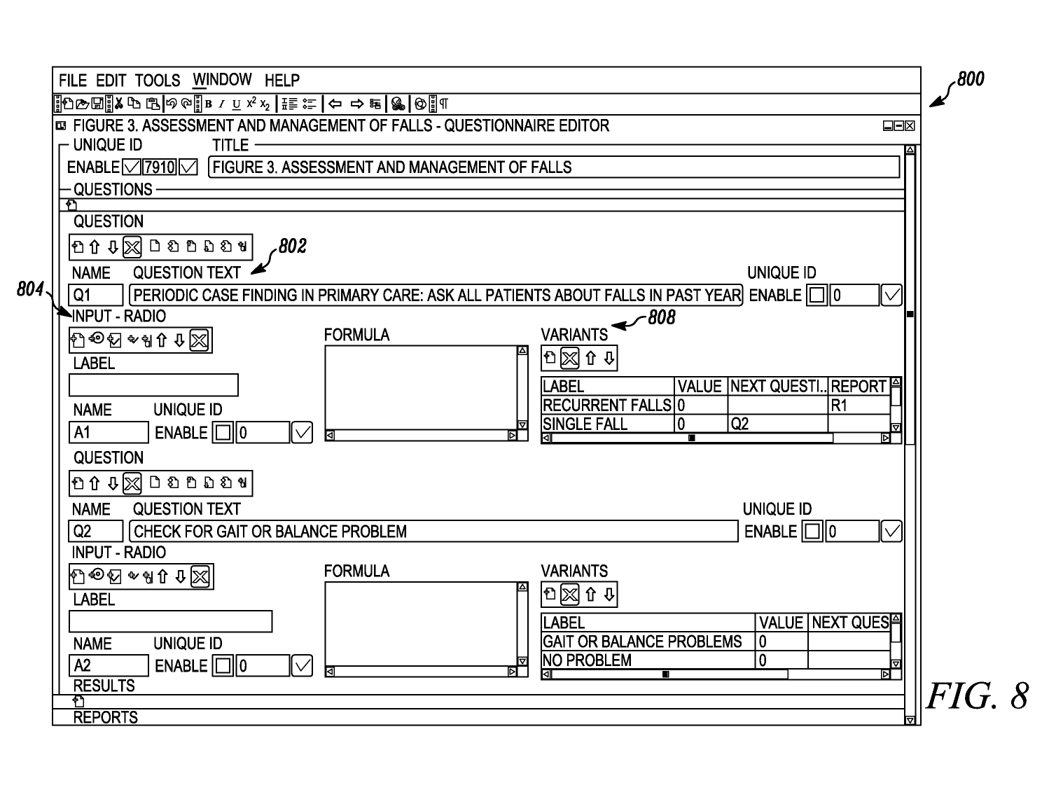

Referring to FIG. 8, an exemplary questionnaire table being edited by a questionnaire editor is shown. Each question text 802 may be associated with an input 804. The input 804 may be numeric, a radio button selection, a drop down menu selection, a variant selection, a text entry, a checkbox, and the like. Results may take the user to another question, a report, other content in project 108, and the like. For example, if the ‘Recurrent Fall’ variant 808 is selected in response to the question ‘Periodic case finding in primary care: ask all patients about falls in past year’, a value of 0 is assigned. The next action taken in the questionnaire for this variant choice is to generate r1, or report #1. In this case, report #1 may present a multifactoral fall assessment. If the variant 808 ‘Single Fall’ is selected, a value of 0 is assigned but the next action is to pose q2, question #2, to the user. Question 2 may be ‘Check for gait or balance problem’. If there is a problem, report #1 is generated. If no problem is selected in response, then report #2 may be generated, where report #2 may simply output “Recommend fall prevention education. In some embodiments, the input 804 may be used in an embedded calculator to generate a result. The result is then used by the questionnaire table to determine the next action, either generating a report, sending the user on to another question, sending the user to content, and the like. In some embodiment, after generating a report, the user may continue to be posed questions.

In embodiments, the tools 402 of the graph database manipulation system 104 may include a bookmark tool, a footnote tool, a hints/rules tool, a history tool, an images tool, an index tool, an inheritance tool, a link tool, a link sources tool, a pop-up tool, a search tool, a list of tables tool, and the like.

In addition, the tools 402 may provide a spell check facility, dynamic syntax highlighting, multiple language syntax highlighting of different languages, hyper linking, checking of broken linking among various content files, and the like. In an embodiment, a link tool may facilitate linking of content files.

In embodiments, the user 312 may use the tools 402 for linking the various sections of the content, or linking content with a particular index element. For example, the user 312 may be interested in linking two portions of content of the project 108. The linking tool may aid in linking the different contents, or linking content to an index element, and the like. For example, to create a link, or a bi-directional edge between two vertices, a user may drag and drop an element from an index onto a portion of content in order to create a link to that content. Alternatively, a link tool may enable setting links among content by indicating which portions of content to link. A link sources tool may enable viewing of all of the sources of inbound links as well as the destination of outbound links. Both ends of the links, outbound and inbound, are editable. For example, when a link exists for a particular hierarchy item or content item, an indication of the link may be present, such as with an icon, a color change, or some other indication. The link sources tool may be accessed, and when the user clicks on the hierarchy item or content that has been linked, the link sources may appear. The link sources that are identified by the link sources tool may be used to access at least one of a destination of a link or a source of an inbound link.

In an embodiment, a history tool enables viewing a complete editing history of the project 108. Using the history tool, a user may readily undo a specific edit, multiple individual changes, redo changes, and the like. The history tool may record the location of the edit as well as the action taken.

In an embodiment, a pop-up tool enables setting a portion of text that appears when an indicator is hovered over content for which a pop-up is set to appear. For example, in viewing a table, the table name may be very long so it may be unwieldy to present at the top of the table. A truncated table name may be presented but a user may use the pop-up tool to indicate the longer table name associated with the truncated name. When an indicator, such as a mouse cursor, interacts with the truncated table name, such as by clicking on it or simply hovering over it, the longer table name may appear in a pop-up.

In an embodiment, a bookmark tool may enable setting a bookmark to a particular hierarchy item or portion of content. When the platform data structure is rendered, the bookmarks may enable a user to readily navigate to bookmarked content.

In an embodiment, a hints/rule tool may enable setting a formatting rule, setting a viewing rule, setting a behavior rule, setting a navigation rule, setting an expand tree rule, setting a no title rule, and the like. For example, if the platform data structure renders as an application with three tabs, one for the Index, a second for Content, and a third for Notes, a rule may indicate that when a user clicks on an item that leads to content, as opposed to another level of the hierarchy, the focus may shift to the second tab, in this case the content tab, such as by highlighting the content tab. In another example, if a ‘no title’ rule is set, when a user clicks on a content item, the content may be displayed without the title of the content. In an example, when the ‘expand tree’ rule is set, instead of showing both the position of the content in the hierarchy as well as the content itself in a viewing pane when the content item is accessed, the tree may be eliminated and only the content in the viewing pane may be visible when the content item is accessed. In another example, when a local navigation rule is set, buttons for moving to a previous and next content item in a hierarchy may appear on the rendered application. A user may navigate through the content using the previous and next buttons as opposed to returning to the hierarchy to make a content selection. In some embodiment, the previous and next buttons may only be useful for navigating within a table of content as opposed to the entire hierarchy of the project 108.

In an embodiment, a footnotes tool may enable creating footnotes associated with content.

In an embodiment, an inheritance tool may enable setting an inheritance edge to enable a field to inherit a content field from another table.

In an embodiment, a search tool may enable search of the content of a project 108. Search may be limited to a matched case, search in the labels, a search for a regular expression, and the like.

In an embodiment, a list of tables tool enables viewing all of the tables associated with a project 108.

In embodiments, the graph database manipulation system 104 may allow multiple users to edit a single graph file simultaneously. For example, a first user and a second user may be connected to each other in a LAN environment; both the users may edit a single graph file and the change made by the first user in the graph file may be dynamically updated on the terminal of the second user. In embodiments, because of the simultaneous editing of graph files, the graph database manipulation system 104 may include logic and control facility to maintain integrity of the data while users simultaneously manipulate the graph.

When the data are exported to a different platform, the required data relationships may already be defined and no effort may be required to restructure or add to the data. The graph data structure of the electronic content may be easily modified to other formats for displaying the contents on an end-user device.

In embodiments, the graph data structure may be a matrix structure. The matrix structure may be an incidence matrix, an adjacency matrix, a Laplacian matrix, a Kirchhoff matrix, an admittance matrix, a distance matrix, and the like. In embodiments, the graph data structure may be a list structure. The list structure may be an incidence list, adjacency list, and the like.

The graph database manipulation system 104 may comprise an API for scripted conversion of source data to a graph format.

In addition, the term platform may be construed as a medium which may be used to access or view the data. Platforms may include operating systems for electronic devices or electronic formats used for printing data, such as and without limitation XML, PDF, PS, PNG, TIFF, and the like. Electronic platforms may have software that may be used to view the exported data, such as native software applications.

In embodiments, the platform associated with the graph database manipulation system 104 may be a PDA, Pocket PC, Smartphone, Web, mobile device, IPHONE, PALM PILOT, desktop computer, printing device, tablet PC, SYMBIAN, ANDROID, BLACKBERRY and the like.

In embodiments, the graph database manipulation system 104 may facilitate the export of a graph data structure to other formats. These formats may be added to the graph database manipulation system 104 as transforms. In embodiments, the term ‘transforms’ may be defined as a software program that may be created for transformation of graphs into data files specific to a platform. Further, the term ‘transform’ may be construed as a software program capable of converting the data from one form to another depending upon the instruction written in the filter program. As described herein, the transform program may convert the existing graph data structure into a format suitable for displaying electronic content on a specific platform.

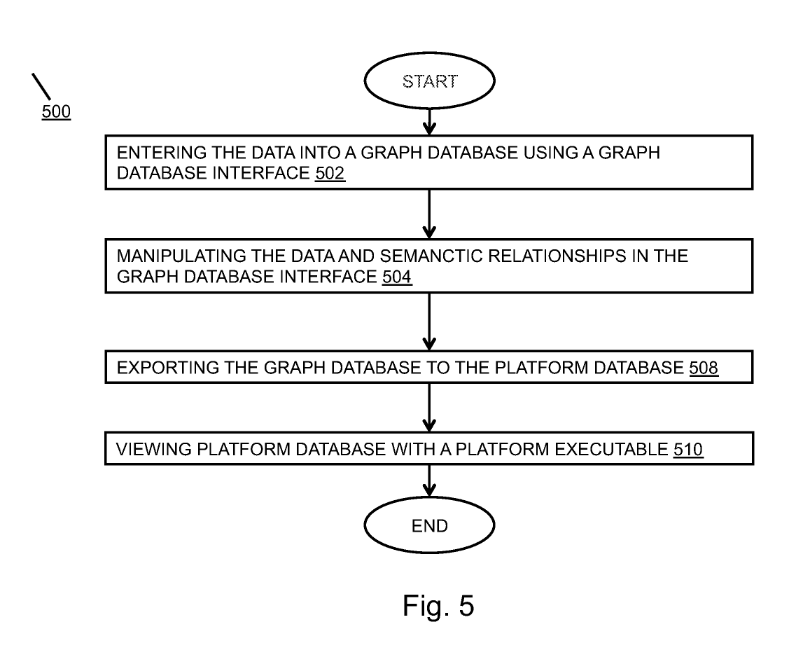

FIG. 5 depicts a flowchart 500 for editing the platform database 308 using graph database manipulation system 104 in accordance with an embodiment of the present invention.

At step 502, the user may enter data in the graph database 302. In embodiments, the user 312 may enter data in the graph database 302 through the graph database manipulation system 104. The user 312 may manipulate the data and semantic relationships using the editors 404 and tools 402 in the graph database interface 304 to create the appropriate semantic relationships in the data. At step 504, a graph data structure may be created.

In embodiments, the graph data structure may be a kind of data structure that may be described by G=(V, E) of sets. V may represent the vertices (or points/nodes) of the graph G whereas E represents the edges (or lines) of the graph. The graph may describe the data in a way that may contain all semantic relationships necessary for processing into a plurality of media (such as print or other electronic media). The graph defines the meaning of the data (vertices) by defining relationships (edges). The graph database does not prescribe a syntax. The data may be numbers, symbols, characters, phrases, sentences, paragraphs, formulas, text, pictures, and videos and the like. In embodiments, the edges in the graph may connect one vertex to another in order to define a relationship. For example, a chapter heading vertex may have an edge over to a vertex representing the content for the chapter of an e-book. Because of these edges, the graph may have the precise relationship between any two connected vertices. This may become useful when editing a graph document. For example, a document may contain many references. References may point to some other part of this document, such as an index entry, or a reference to a table or figure. References may usually be handled via links that may be clicked on to view the target data. In XML or other electronic formats intended for print, the target information may be missing data to indicate incoming links. Since there are edges in the graph format, all targets may have the data to indicate every incoming link. By corollary, the target and source of every link may be easily editable.

In an embodiment, since relationships are defined by edges, there may be no need to change the definition, position, or formatting of a vertex. Edges may be connected, removed, altered, and the like. New edges may also be defined to describe new relationships and behaviors to generate the graph data structure.

At step 508, the user 312 may export the graph data structure to the desired platform database 302. At step 510, the platform database 308 may then be installed to a platform and viewed with a platform executable 310.

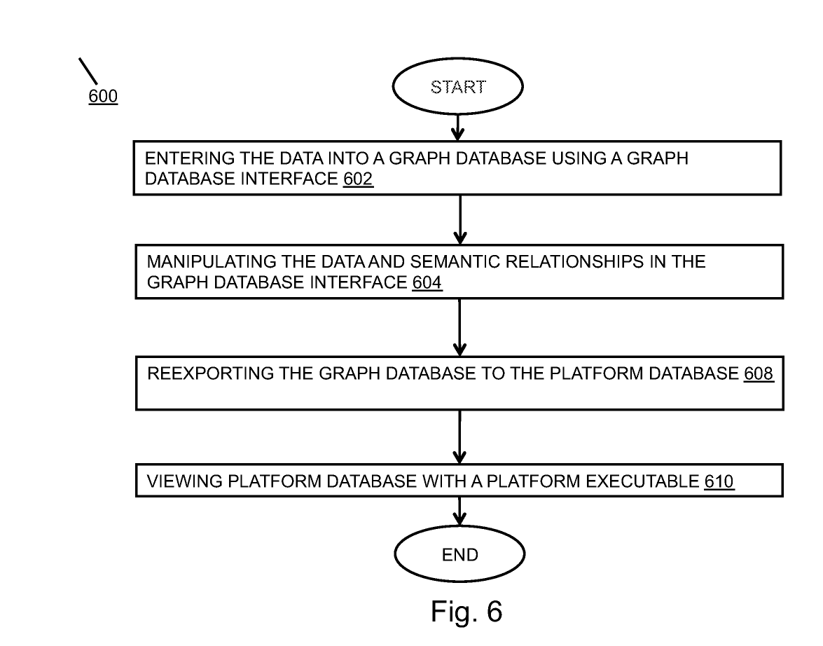

FIG. 6 depicts a flowchart 600 for updating the platform database 308 using the graph database manipulation system 104 in accordance with another embodiment of the present invention

At step 602, the user 312 may enter the data in the graph database 302. In embodiments, the user 312 may enter the data in the graph database 302 through the graph database manipulation system 104. At step 604, the user may manipulate the earlier graph structure using the editors 404 and tools 402 in the graph database manipulation system 104 to create the new semantic relationships in the data. The graph data structure manipulation system 104 may allow multiple users to edit the graph for manipulating existing semantic relationships. Alternatively, the graph may be edited exclusively by a single user 312 for manipulating the graph data structure. The graph data structure may be stored in graph database 302. At step 608, the graph data structure may be re-exported to the platform database 308. At step 610, the platform database 308 may be viewed by the platform executable 310.

For example, a project 108 may have a formula for calculating the right dosage for typhoid patients. This formula may need some correction. In this case, the user 312 may edit the formula using a calculator editor and re-export the graph data structure as a platform data structure. This updated platform data structure may be provided to end-users across many different platforms. Updates to platform data structures may be made incrementally, wirelessly, and the like.

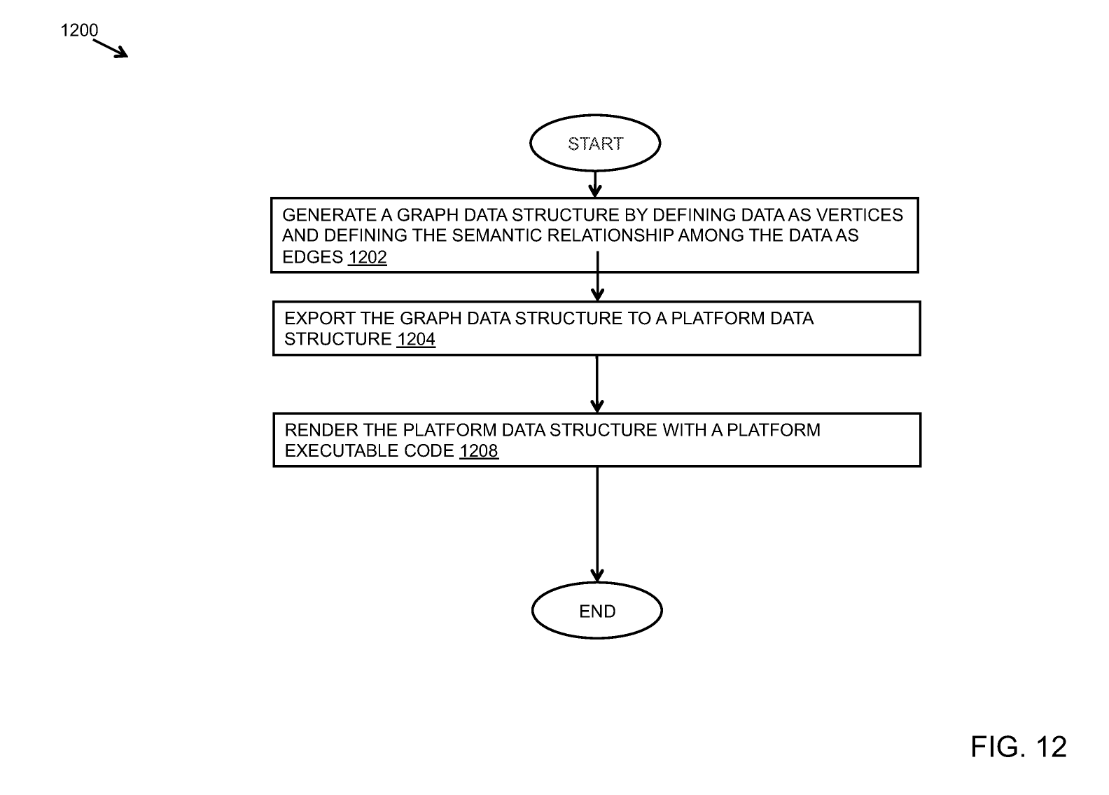

Referring to FIG. 12, a method may include the steps of generating a graph data structure by defining data as vertices and defining the semantic relationship among the data as edges 1202, exporting the graph data structure to a platform data structure 1204, and rendering the platform data structure with a platform executable code. In the method, the semantic relationship may contain all information necessary for processing the graph data structure into a plurality of distinct media 1208.

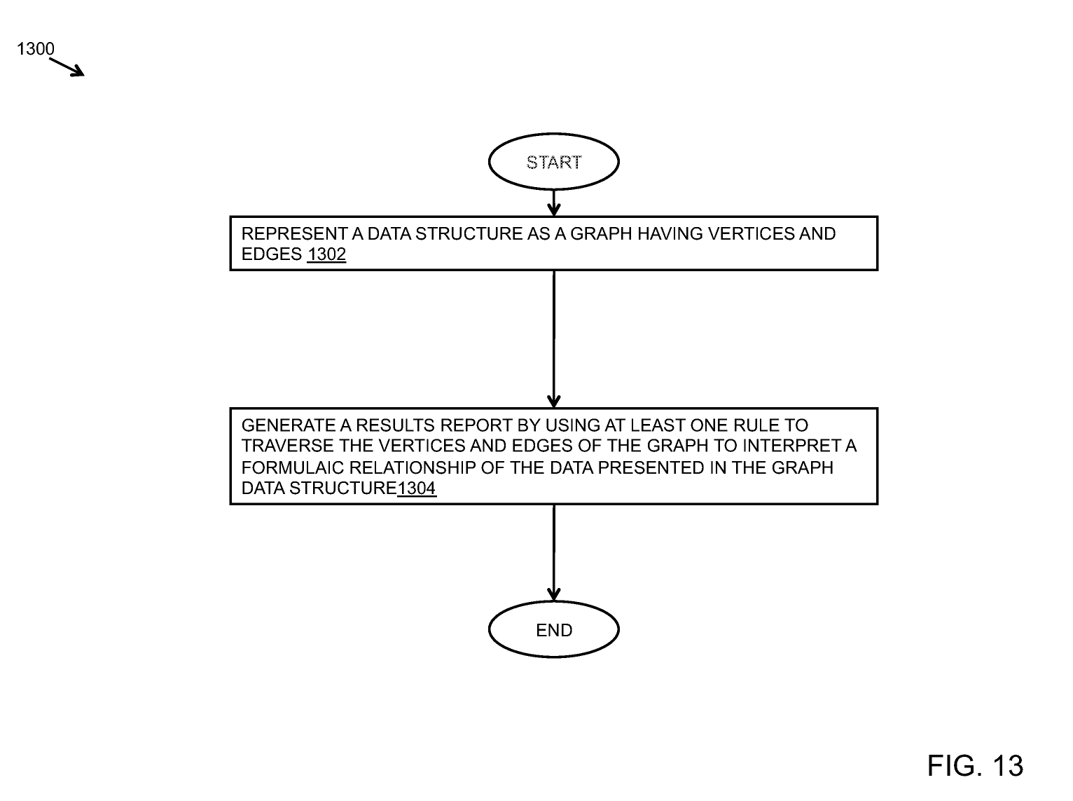

Referring to FIG. 13, a method may include the steps of representing a data structure as a graph having vertices and edges 1302, wherein each input field of the data structure is defined as a vertex in the graph and each link between input fields is defined as an edge between the vertices to form the graph, wherein each of the edges contains information about a formulaic relationship between a pair of vertices connected by the edge, and generating a results report by using at least one rule to traverse the vertices and edges of the graph to interpret the formulaic relationship of the data presented in the graph data structure 1304.

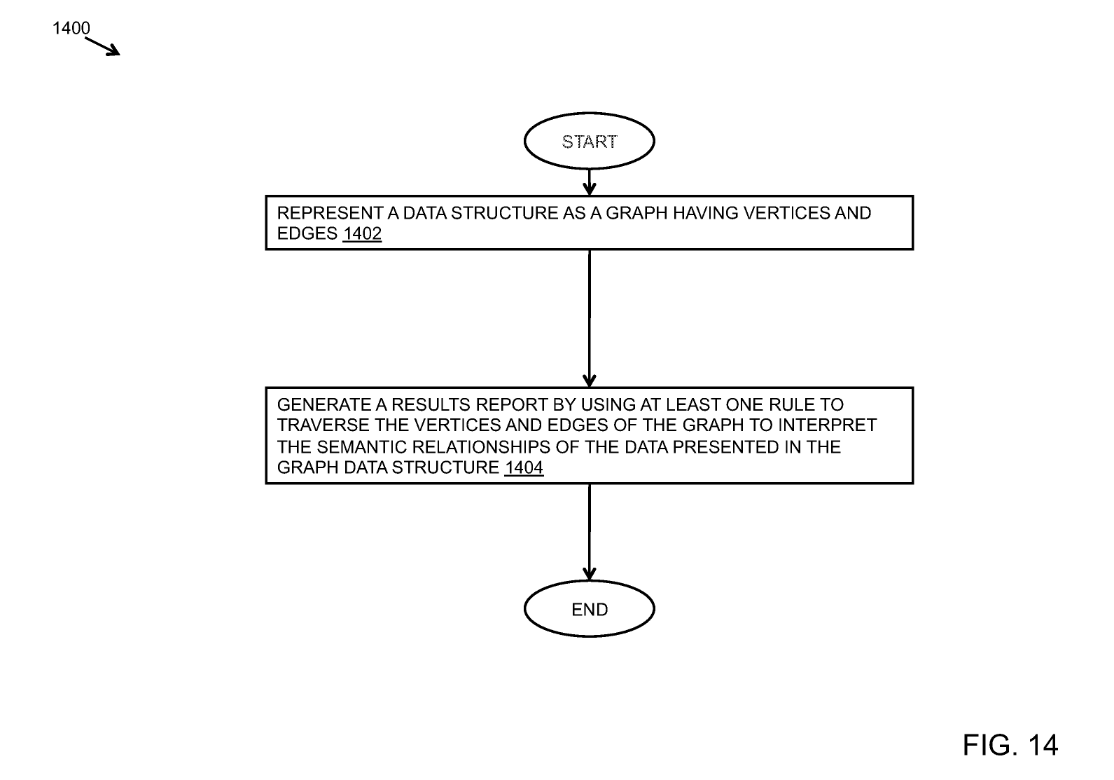

Referring to FIG. 14, a method may include the steps of representing a data structure as a graph having vertices and edges 1402, wherein each input field, question, formula, and score of the data structure is defined as a vertex in the graph and each link between input fields is defined as an edge between the vertices to form the graph, wherein each of the edges contains information about a semantic relationship between a pair of vertices connected by the edge, and a results report generated by using at least one rule to traverse the vertices and edges of the graph to interpret the semantic relationships of the data presented in the graph data structure 1404, wherein a user's answer to at least one question is stored in connection with at least one vertex or at least one edge in the graph data structure and wherein the user's answer is used in connection with the rule.

The present invention may enable proper viewing of electronic content in multiple devices and has numerous advantages. For example, the present invention may provide a set of modular tools for creation or manipulation of the graph data structure in specific ways. Once a graph data structure has been created, it may be exported to different mediums, such as native software for a mobile device, a website, a book, or computer software. This may effectively create a single source database that may be translated simultaneously to a plurality of media, such as a plurality of forms of electronic and print platforms. The system implemented by using this invention may be modular and may allow additional features to be added as well as support for new platforms and mediums. The creation of the software and print products may be done simultaneously and in real time.

The methods and systems described herein may be deployed for content derived from across many different markets, verticals, industries, and applications. For example, the content may be medical, government-related, travel-related, educational, reference-related, standardized testing-related, and the like.

The methods and systems described herein may be deployed in part or in whole through a machine that executes computer software, program codes, and/or instructions on a processor. The processor may be part of a server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law

All documents referenced herein are hereby incorporated by reference.

1. A machine readable medium, the machine readable medium having program instructions stored thereon, for ordering data stored in a data structure, executable by a processing unit, the program instructions comprising the steps of:
representing a graph data structure as a graph having vertices and edges, wherein each data point is defined as a vertex in the graph and each link between data points is defined as an edge between the vertices to form the graph, wherein each of the edges contains information about a semantic relationship between a pair of vertices connected by the edge;
generating one or more platform data structures by using at least one rule to traverse the vertices and edges of the graph data structure to interpret the order of data presented in the graph data structure, wherein the platform data structure is specific to a native platform application; and
rendering the platform data structure on the platform, wherein the platform data structure comprises information to represent the data on the platform,
wherein changes to the semantic relationships among the data are made in the source graph data structure in order to update the one or more platform data structures.

2. The medium of claim 1, wherein the semantic relationship contains all of the information necessary for processing the graph data structure into the one or more platform data structures.

3. The medium of claim 1, further comprising manipulating the semantic relationships among the data in the graph data structure using a graph data structure interface.

4. The medium of claim 3, wherein the graph data structure interface enables multiple users to edit a single graph data structure simultaneously.

5. The medium of claim 1, wherein the graph data structure is a matrix structure.

6. (canceled)

7. The medium of claim 1, wherein the graph data structure is a list structure.

8. (canceled)

9. The medium of claim 1, wherein the platform data structure is at least one of a PDF format, a Reader format, an XML format, a Palm format, a PocketPC format, a Web format, a Print format, a personal computer format, and a mobile device format.

10-13. (canceled)

14. The medium of claim 1, wherein the platform data structure is a native application format.

15. The medium of claim 1, wherein the graph data structure is stored as a table of at least one of a vertex, an edge, and a parameter.

16-36. (canceled)

37. The medium of claim 1, wherein the semantic relationship is defined by linking at least two vertices to form at least one edge.

38-41. (canceled)

42. A system, comprising:
a graph data structure comprising at least two points of data connected by a semantic relationship, the semantic relationship enabling processing of the graph data structure into a plurality of distinct types of media; and
a transform that converts the graph data structure into a platform data structure specific to a native platform application, wherein the platform data structure comprises information to represent the data on the platform,
wherein changes to the data are made in the graph data structure in order to update one or more platform data structures.

43. The system of claim 42, further comprising a graph data structure interface for manipulating the semantic relationships among the data in the graph data structure.

44. The system of claim 43, wherein the graph data structure interface enables multiple users to edit a single graph data structure simultaneously.

45. The system of claim 42, wherein the graph data structure is a matrix structure.

46. (canceled)

47. The system of claim 42, wherein the graph data structure is a list structure.

48. (canceled)

49. The system of claim 42, wherein the platform data structure is at least one of a PDF format, a Reader format, an XML format, a Palm format, a PocketPC format, a Web format, a Print format, a personal computer format, and a mobile device format.

50-54. (canceled)

55. The system of claim 42, wherein the data structure is stored as a table of at least one of a vertex, an edge, and a parameter.

56-76. (canceled)

77. The system of claim 42, wherein the semantic relationship is defined by linking at least two vertices, a target vertex and a source vertex, to form at least one edge.

78-81. (canceled)

82. A method, comprising:
generating a graph data structure by defining data as vertices and defining the semantic relationship among the data as edges;
exporting the graph data structure to a platform data structure; and
rendering the platform data structure with a platform executable code.

83. The method of claim 82, wherein the semantic relationship contains all syntax necessary for processing the graph data structure into a plurality of distinct media.

84-90. (canceled)
